(19) United States
(12) Patent Application Publication
(10) Pub. No.: US 2010/0160089 A1
(43) Pub. Date: Jun. 24, 2010

(54) APPAPATUS AND METHOD FOR PROVIDING GOLFING INFORMATION

(76) Inventors: Tzu-Wei Lin, Taipei City (TW); Meng-Hsiang Chang, Taipei City (TW); Chien-Lung Chen, Taipei City (TW); Chi-Wen Chen, Taiwan City (TW)

Correspondence Address: GENE I. SU, 17F-1, No. 151, SEC. 4, XINYI ROAD, TAIPEI, TW

(21) Appl. No.: 12/339,467

(22) Filed: Dec. 19, 2008

(51) Int. Cl. A63B 57/00; A63B 69/36; G01S 5/14

(52) U.S. Cl. 473/404; 473/409; 473/407; 700/91; 700/92; 342/357.08; 342/357.13

(57) ABSTRACT

One embodiment of the present invention sets forth a method, which includes the steps of collecting data associated with a golfing activity, comparing a condition associated with a first golfing event with the data associated with the golfing activity to determine an occurrence of the first golfing event, and performing an action in response to at least the first golfing event and a second golfing event occurring at a specified sequence.

### BACKGROUND OF THE INVENTION

### Description of the Related Art

Unless otherwise indicated herein, the approaches described in this section are not prior art to the claims in this application and are not admitted to be prior art by inclusion in this section.

As the popularity of golf continues to grow, an increasing number of accessory products associated with golf have also been commercialized. Various types of portable devices specifically designed to assist golfers are currently available. In general, these conventional portable devices require extensive maneuvering on the part of the golfers. For example, when a golfer finishes the play of a golf hole and moves on to the next hole, such a conventional portable device needs to receive certain manually entered input from the golfer (e.g., the numeric number of the next hole) before performing an action (e.g., presenting the map information associated with the next hole). In addition, the conventional portable device typically is not designed to store or process the information associated with the golfer's round. For example, the conventional portable device does not record any prior driving distances associated with any of the golfer's clubs and is thus unable to make an intelligent club selection suggestion. As has been shown, the rudimentary functions supported by the conventional portable device are insufficient to assist a golfer to improve his or her game or enhance the golfer's enjoyment of the game.

### SUMMARY OF THE INVENTION

An apparatus and method for providing golfing information is disclosed. One embodiment of the present invention sets forth a method, which includes the steps of collecting data associated with a golfing activity, comparing a condition associated with a first golfing event with the data associated with the golfing activity to determine an occurrence of the first golfing event, and performing an action in response to at least the first golfing event and a second golfing event occurring at a specified sequence.

At least one advantage of the present invention disclosed herein is the capabilities to automatically generate and present golfing related information to further enhance the enjoyment of playing golf.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a simplified block diagram illustrating a personal golf game assistant (PGGA), according to one embodiment of the present invention;

FIG. 1B is a schematic diagram further showing an input device of the PGGA of FIG. 1A, according to one embodiment of the present invention;

FIG. 1C illustrates yet another implementation of the PGGA of FIG. 1A, according to one embodiment of the present invention;

FIG. 1D illustrates still another implementation of the PGGA 100 of FIG. 1A, according to one embodiment of the present invention;

FIG. 2 illustrates a digital representation of a typical golf hole;

FIG. 3 is a flow chart illustrating a process that the PGGA of FIG. 1A is configured to perform, according to one embodiment of the present invention;

FIG. 4A is a flow chart illustrating some actions performed by the PGGA of FIG. 1A in response to two golfing events occurring at a specified sequence, according to one embodiment of the present invention;

FIG. 4B is another example illustrating some other actions performed by the PGGA of FIG. 1A in response to the occurrence of at least two golfing events in a specified sequence, according to one embodiment of the present invention; and

FIG. 4C is an example illustrating the actions performed in a par-three hole by the PGGA of FIG. 1A in response to the occurrence of at least two golfing events in a specified sequence, according to one embodiment of the present invention.

### DETAILED DESCRIPTION

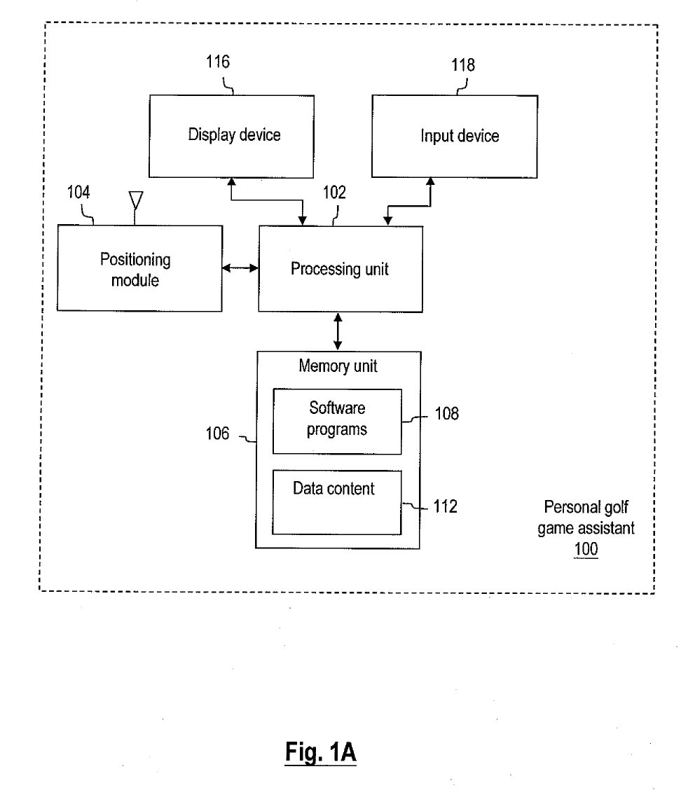

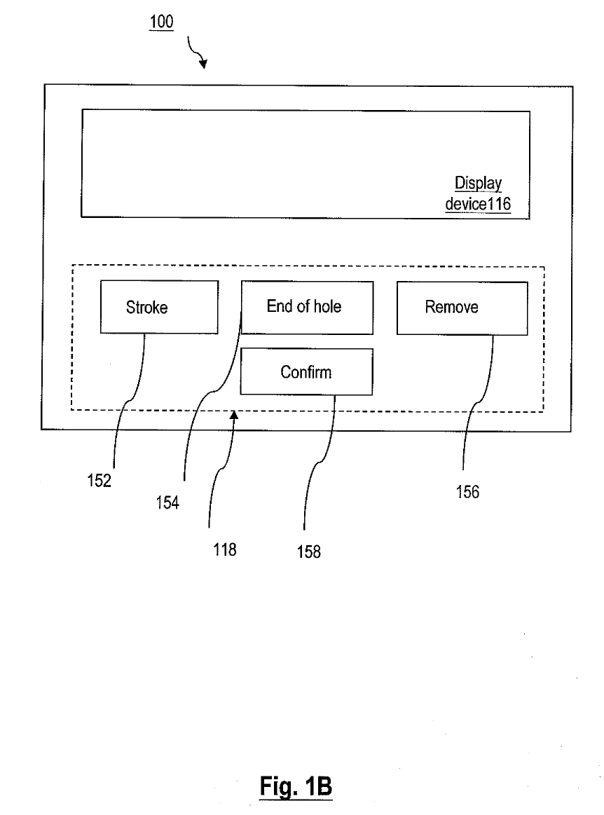

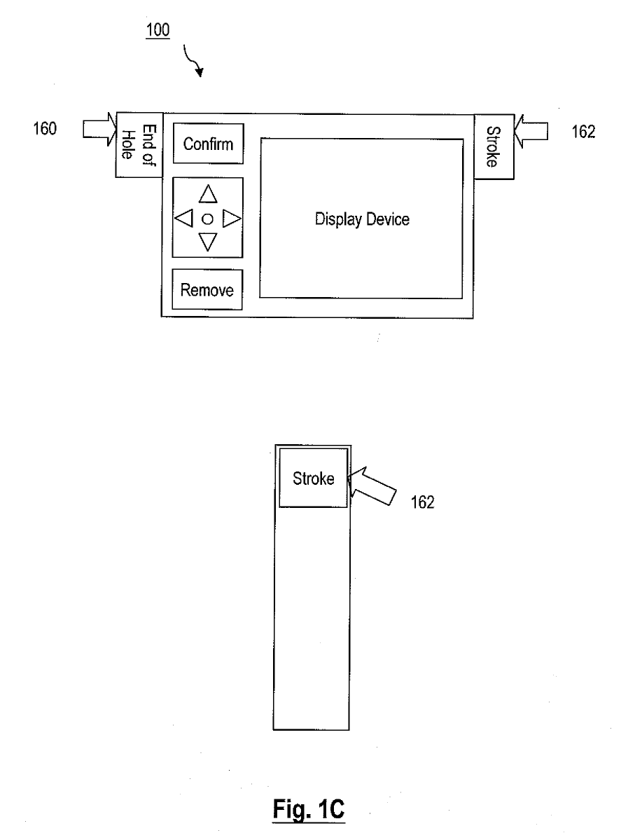

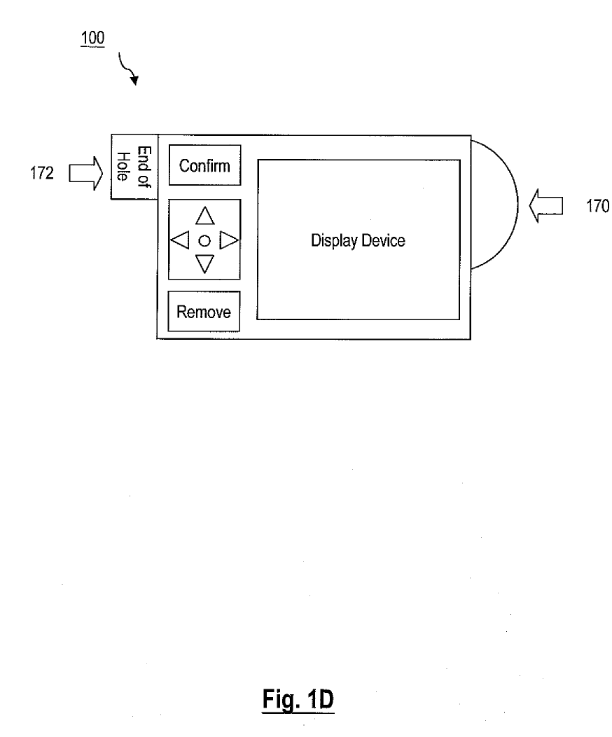

FIG. 1A is a simplified block diagram illustrating a personal golf game assistant (PGGA) 100, according to one embodiment of the present invention. The PGGA 100 includes a processing unit 102, a positioning module 104, a memory unit 106 including a software program 108 and data content 112, a display device 116, and an input device 118. The processing unit 102 is configured to control the operations of the positioning module 104, execute the software program 108, process the data content 112, send image data to the display device 116, and receive input information from the input device 118. In one implementation, the positioning module 104 is a satellite-based global positioning (GPS) system. The positioning module 104 locates and tracks the position of the PGGA 100. In one implementation, the positioning module 104 acquires the position of the PGGA 100 at a predetermined rate (e.g., one second) and stores the acquired positional information in the data content 112. When the button on the input device 118 is pressed, the processing unit 102 retrieves the latest positional information stored in the data content 112. In another implementation, in response to the push of the button on the input device 118, a corresponding signal is sent to the processing unit 102, which in turn communicates with the positioning module 104 to acquire the positional information of the PGGA 100. With the information collected by the PGGA 100, including the positional information, the PGGA 100 is configured to generate various golfing information and display some of such information via the display device 116.

In conjunction with FIG. 1A, FIG. 1B is a schematic diagram further showing the input device 118 of the PGGA 100 according to one embodiment of the present invention. The input device 118 includes multiple input buttons such as, without limitation, a “stroke” button 152, an “end of hole” button 154, and a “remove” button 156, and a “confirm” button 158. The “stroke” button 152, when pressed, adds one stroke to an activities record. This activities record, in one implementation, is a part of the data content 112 shown in FIG. 1A. There may be an activities record for each hole of play, and there may also be a total activities record that aggregates the activities records of all the holes of play. The pushing of the “stroke” button 152 can also trigger the positioning module 104 to locate the position of the PGGA 100 close to the time the button is pressed. Since the “stroke” button 152 is typically pushed either when a swing is about to be made or immediately after a swing is made, the location of the PGGA 100 should also closely correspond to the position of the golf ball either immediately before or immediately after the ball is struck. The pushing of the “stroke” button 152, as discussed above, may retrieve the latest positional information from the data content 112 of the PGGA 100. The “end of hole” button 154, when pressed, indicates that the play of a hole is completed. The “remove” button 156, when pressed, removes one stroke from an activities record, if the “stroke” button 152 is erroneously pressed. Lastly, the “confirm” button 158 is mainly used to respond to questions shown on the display device 116. It should be noted that any of the buttons mentioned above can be implemented as a mechanical button, a touch-screen type button, a trackball, a joystick, or a jog wheel.

FIG. 1C illustrates yet another implementation of the PGGA 100 of FIG. 1A, according to one embodiment of the present invention. Here, the “stroke” button 152 shown in FIG. 1B is implemented as a mechanical button on a side of the PGGA 100, such as a first side button 162 of FIG. 1C. Similarly, the “end of hole” button 154 of FIG. 1B can also be implemented as a mechanical button on a side of the PGGA 100, such as a second side button 160 of FIG. 1C.

FIG. 1D illustrates still another implementation of the PGGA 100 of FIG. 1A, according to one embodiment of the present invention. Unlike the mechanical buttons shown in FIG. 1C, the PGGA 100 includes a jog wheel 170, where it can be rotated to increment strokes. In this implementation, the PGGA 100 optionally includes a mechanical button, such as a side button 172, like the ones shown in FIG. 1C.

It should be noted that any of the functions associated with the buttons described above and illustrated in FIGS. 1B-1D can be implemented in other ways. For example, instead of pressing the “end of hole” button, completing play for a hole can be determined by checking whether the position of the PGGA 100 is no longer within the boundary of the hole.

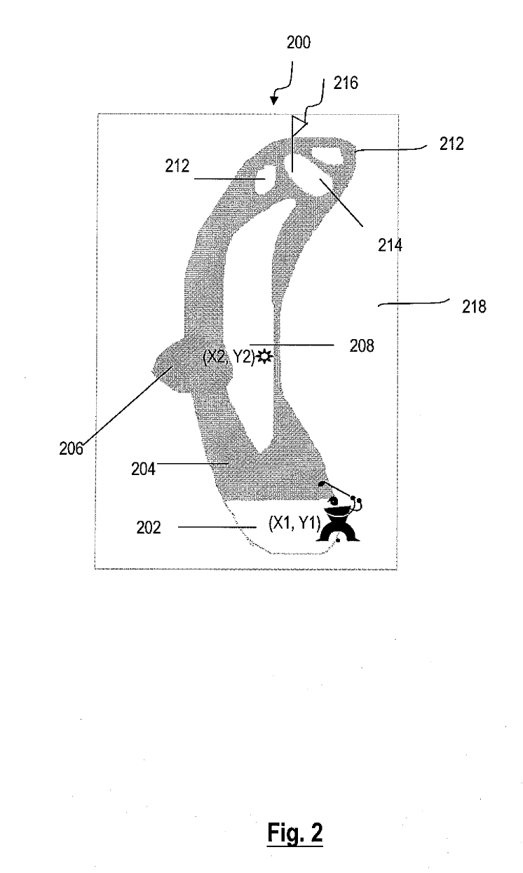

In conjunction with FIG. 1B, FIG. 2 illustrates a digital representation of a typical golf hole 200. The golf hole 200 may include terrains such as a tee box 202, a rough area 204, a water hazard 206, a fairway 208, bunkers 212, a green 214 where a flag 216 is placed, and an out-of-bound (OB) area 218. Generally, when a golfer is in the tee box 202 getting ready to tee off the golf ball or immediately after striking the golf ball, the “stroke” button 152 can be pressed so that one stroke is added to the activities record for the golf hole 200, and an initial position (X1, Y1) is established. After teeing off, the golfer typically moves to the proximity of a new position of the golf ball. Similarly, immediately before or after the golf ball is struck, the “stroke” button 152 can be again pressed to cause one more stroke to be added to the activities record for the golf hole 200 and establish a second position (X2, Y2).

Continuing with the example above, after the “stroke” button 152 is pressed each time, certain data associated with a golfing activity is collected by the PGGA 100. Specifically, the data collected here include, without limitation, the one stroke increment and the approximate golf ball position, such as the initial position (X1, Y1) or the second position (X2, Y2).

Based on the collected data, the PGGA 100 is configured to determine whether a certain golfing event has occurred. A golfing event is at least associated with one condition. So, if the collected data satisfies all the conditions associated with the golfing event, then the golfing event is considered to have “occurred.” To illustrate, in conjunction with FIG. 2, an example of a golfing event is a player starting play for a golf hole, such as the golf hole 200. In one implementation, this “start play for hole” event may be associated with the condition of the position of the PGGA 100 being within the boundary of the golf hole 200. In another implementation, the “start play for hole” event may be associated with the condition of the PGGA being within a predetermined region of the golf hole. So, if the location of the PGGA 100 indeed satisfies the condition associated with the “start play for hole” event, then the event is deemed to have occurred. In another example, a golfing event of a player “teeing off from the tee box 202” may be associated with the conditions of “one stroke increment” and “one stroke in the activities record for the golf hole 200.” Therefore, if the activities record for the golf hole 200 indicates that a stroke is added and the score is at one stroke, then this golfing event of “teeing off from the tee box 202 is considered to have “occurred.” Other examples of the golfing events are further described in conjunction with figures in subsequent paragraphs.

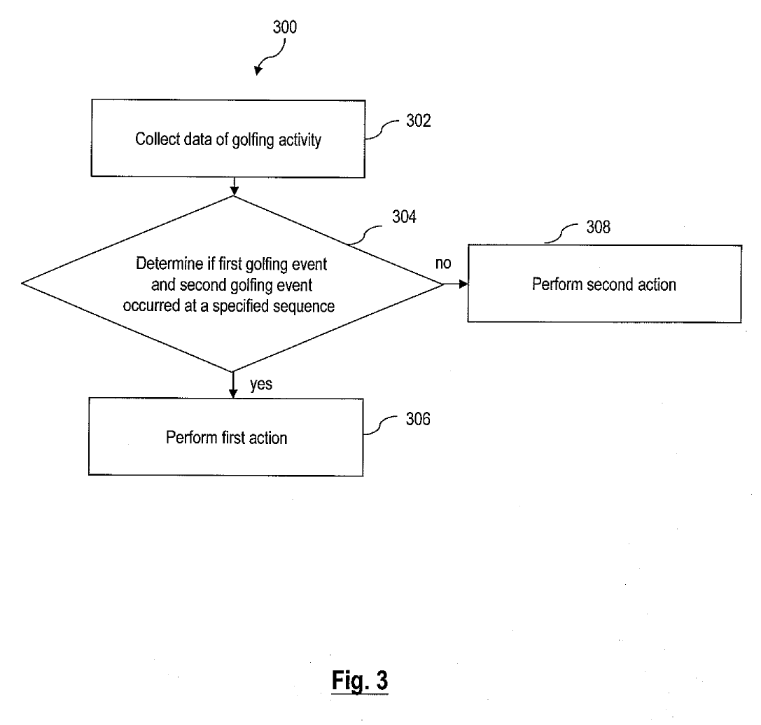

FIG. 3 is a flow chart illustrating a process 300 that the PGGA 100 of FIG. 1A is configured to perform, according to one embodiment of the present invention. In step 302, the PGGA 100 collects data associated with golfing activities. In one implementation, the PGGA 100 collects input signals entered by a golfer carrying the PGGA 100. In another implementation, the PGGA 100 collects external signals, such as, without limitation, radio frequency identification (RFID) signals transmitted from a RFID device attached to a golf club. In step 304, the PGGA 100 determines whether the first golfing event and the second golfing event occurred at a specified sequence based on the data collected in step 302. Suppose the specified sequence is for the first golfing event to occur before the second golfing event. In one implementation, the PGGA 100 is configured to check whether the first golfing event has occurred. If so, then the PGGA 100 proceeds to check if the second golfing event has occurred. Otherwise, the PGGA 100 does not even look for the second golfing event. Alternatively, the PGGA 100 is configured to check whether both the first golfing event and the second golfing event have occurred. If so, then the PGGA 100 relies on the timing information associated with the two golfing events to determine the occurrence sequence. Then, the PGGA 100 can determine whether such an occurrence sequence is the same as the specified sequence.

If indeed the two golfing events occur at the specified sequence, then the PGGA 100 performs a first action in step 306. Otherwise, the PGGA 100 performs a second action in step 308. Referring back to FIG. 2, some examples of the actions that can be performed by the PGGA 100 include, without limitation, calculating distances (e.g., how far apart between (X1, Y1) and (X2, Y2)), determining whether there is any fairway in regulation (FIR) (e.g., whether (X2, Y2) is within the boundary of the fairway 208), displaying a question (e.g., asking whether the play for a particular golf hole is completed), and suggesting a club for the next stroke of play. Although the process 300 involves the first golfing event and the second golfing event, the PGGA 100 is also capable of tracking and responding to more than two golfing events that occur in a certain sequence.

The collected positional information (X1, Y1) and (X2, Y2) can be used to calculate the distance between (X1, Y1) and (X2, Y2) and determine whether there is FIR. The distance calculation and the FIR determination are some examples of the PGGA 100 processing the data (e.g., the positional information).

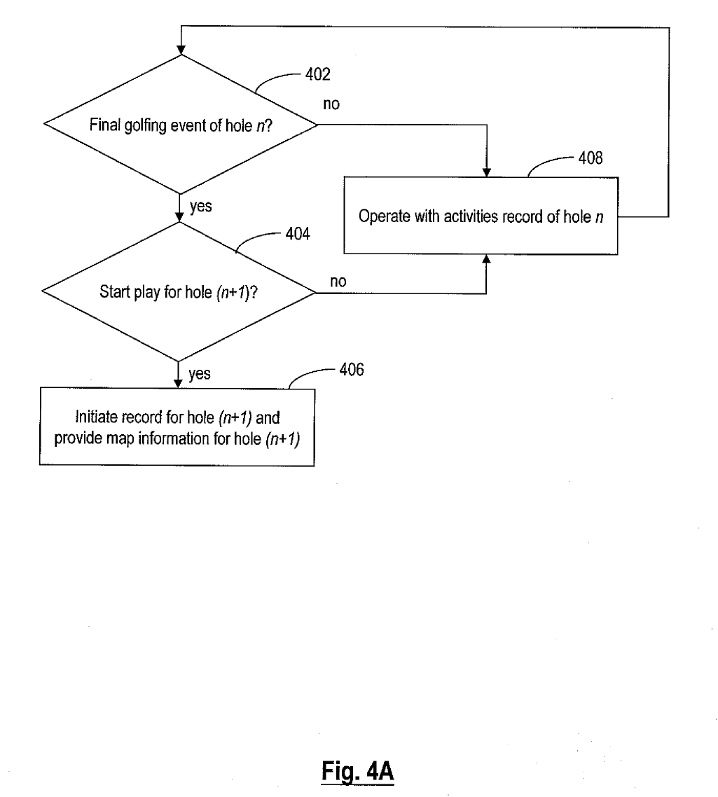

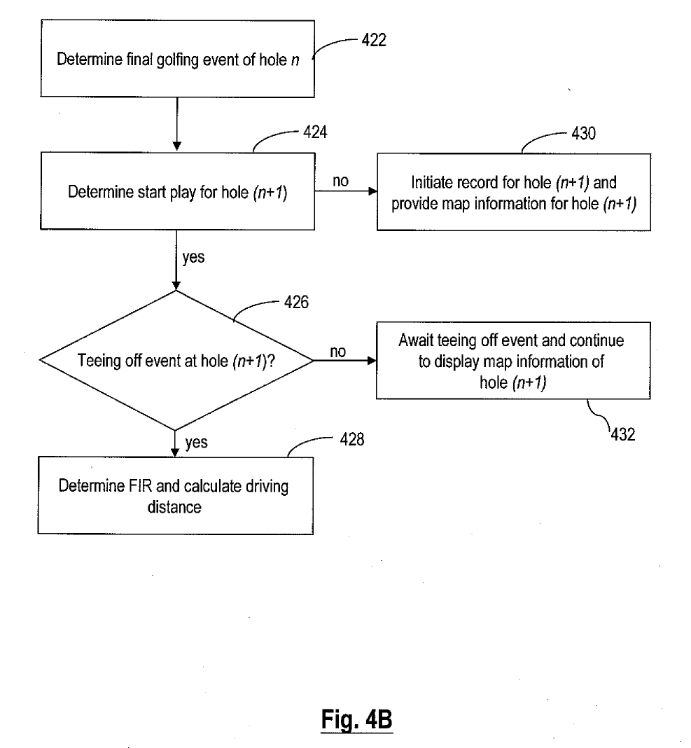

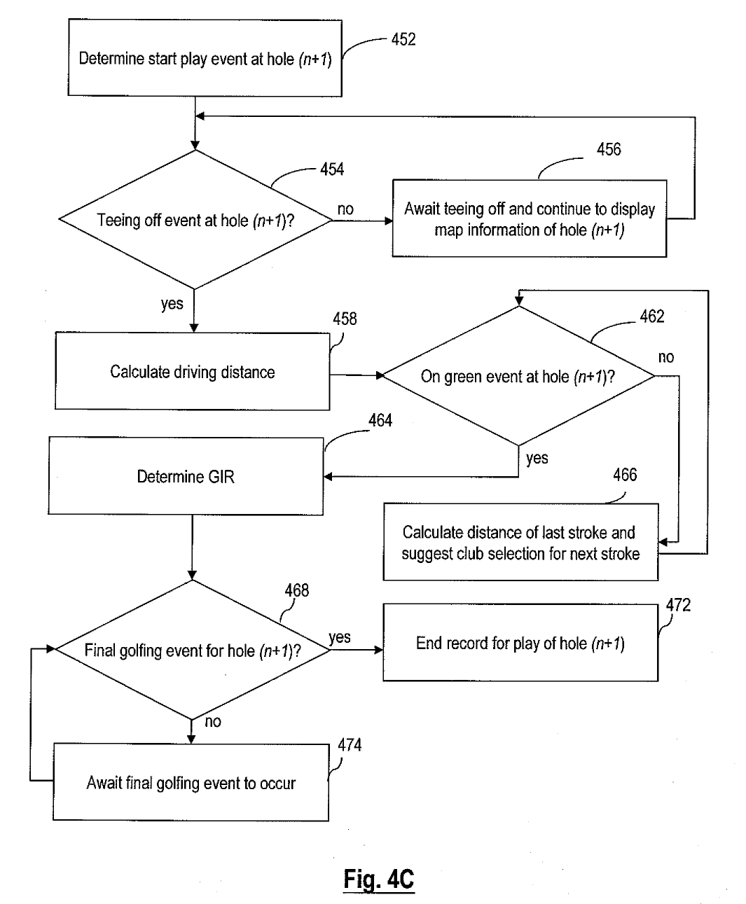

FIG. 4A is a flow chart illustrating some actions performed by the PGGA 100 of FIG. 1A in response to two golfing events occurring at a specified sequence, according to one embodiment of the present invention. In step 402, the PGGA 100 determines whether a “final golfing event for hole n” has occurred. In one implementation, this “final golfing event for the hole n” is deemed to have occurred if the “end of hole” button 154 shown in FIG. 1B is pressed as the play of hole n concludes. In another implementation, the same “final golfing event for hole n” is considered to have “occurred” if the “confirm” button 158 shown in FIG. 1B is pressed to affirmatively respond to a question of whether the play of hole n is completed shown on the display device 116 of the PGGA 100. It is worth noting that the display of this question, in one implementation, is by itself an action performed in response to the occurrence of at least two golfing events in a specified sequence. For example, the first of the two golfing events may be the PGGA 100 “on the green of hole n.” Then this golfing event is followed by the second of the two golfing events, which is the PGGA 100 “starts play for hole (n+1)” event.

If the “final golfing event for hole n” is deemed to have occurred in step 402, then the process continues to step 404 to check the occurrence of the second golfing event, the “start play for (n+1)” event. If the result comes back positive, then the PGGA 100 performs the actions of initiating an activities record for hole (n+1) and also providing the map information of hole (n+1) in step 406. On the other hand, if either of the steps 402 and 404 is not deemed to have occurred, the PGGA 100 continues to operate with the activities record for hole n in step 408.

FIG. 4B is another example illustrating some other actions performed by the PGGA 100 of FIG. 1A in response to the occurrence of at least two golfing events in a specified sequence, according to one embodiment of the present invention. As discussed above in conjunction with FIG. 4A, the PGGA 100 is configured to perform the actions in step 430 in response to the occurrence of the “final golfing event for hole n” in step 422 followed by the occurrence of the “start play for hole (n+1) event” in step 424. If the PGGA 100 determines in step 426 that the “teeing off at hole (n+1)” event has occurred following the occurrences of the golfing events of steps 422 and 424, then, in one implementation, the actions to be performed in step 428 are to calculate a driving distance (e.g., between (X1, Y1) and (X2, Y2) as shown in FIG. 2) and to determine whether there is FIR (e.g., whether the (X2, Y2) position of FIG. 2 is within the boundary of the fairway 208). The driving distance and the FIR data can be stored in the activities record, displayed on the display device 116, further processed to generate relevant golfing information, or utilized in any combination of the aforementioned ways. In one implementation, the recorded FIR information may be used to calculate and update a percentage of FIR as a round of play proceeds. Also, the recorded driving distances may be mapped to club selections, so that the PGGA 100 may proactively make club selection suggestions. On the other hand, if the PGGA 100 of FIG. 1A fails to find the “teeing off event at hole (n+1)” in step 426, then the PGGA 100, in one implementation, continues to wait for such an event while displaying the map information of hole (n+1) in step 432.

FIG. 4C is an example illustrating the actions performed in a par-three hole by the PGGA 100 of FIG. 1A in response to the occurrence of at least two golfing events in a specified sequence, according to one embodiment of the present invention. After having determined that the “start play for hole (n+1) event” has occurred in step 452, the PGGA 100 checks whether the “teeing off event at hole (n+1)” has occurred in step 454. As discussed above, if the teeing off event has not occurred, then the PGGA 100 is configured to wait for the event and may continue to display the map information of hole (n+1) in step 456. If the “teeing off event at hole (n+1)” indeed occurs subsequent to the occurrence of the “start play for hole (n+1) event,” then the PGGA 100 is configured to calculate a driving distance in step 458. In step 462, the PGGA 100 determines if an “on green event” has occurred. In one implementation, the “on green event” is associated with two conditions. One condition is the occurrence of a stroke increment, and the other condition is the location of the PGGA 100 within a green region, such as the green 214 of FIG. 2. When the “stroke” button is pressed again to add one more stroke to the record and to help locate the golf ball now at the green, the “on green” event could be considered “occurred.” With the “start play for hole (n+1) event,” the “teeing off event at hole (n+1),” and the “on green event at hole (n+1)” occur successively, the PGGA 100, in one implementation, is configured to establish whether there is green in regulation (GIR) in step 464. In this par-three example, the position of the golf ball after the first stroke of this hole (n+1) needs to be on the green of hole (n+1) to be considered as GIR.

Thereafter, the PGGA 100 is further configured to determine if the “final golfing event for hole (n+1)” has occurred in step 468. If such an event has occurred, then the PGGA 100 may conclude the activities record for hole (n+1) in step 472. Otherwise, the PGGA 100 waits for the final golfing event to occur in step 474.

If no “on green event at hole (n+1)” is deemed to have occurred in step 462 (e.g., the golf ball is not on the green), the PGGA 100, in one implementation, proceeds to step 466 to perform actions such as calculating the distance from the present location to the hole and making a club selection suggestion. It is worth noting that events other than the “on green event at hole (n+1)” may occur subsequent to the occurrence of the “teeing off event at hole (n+1).” Some examples include, without limitation, “in bunker event at hole (n+1)” and “in water hazard event at hole (n+1).” The PGGA 100 may perform different actions in step 466 in response to the occurrences of such events.

It should be apparent to a person having ordinary skills in the art to recognize although some of the above discussions relate to a par-three hole, the same event-driven method and system apply to other types of holes (e.g., par-four and par-five holes). Moreover, the aforementioned events are for illustration purposes and shall not be construed to limit the scope of the present invention.

One embodiment of the present invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, ROM chips, or any type of solid-state non-volatile semiconductor memory) on which information is permanently stored; and (ii) writable storage media (e.g., floppy disks within a diskette drive, CD-RW disks, DVD-RW disks, flash memory, hard-disk drive, or any type of random-access memory) on which alterable information is stored. The above examples, embodiments, instruction semantics, and drawings should not be deemed to be the only embodiments, and are presented to illustrate the flexibility and advantages of the present invention as defined by the following claims.

We claim:

1. A method for providing golfing information, the method comprises:
collecting data associated with a golfing activity;
comparing a condition associated with a first golfing event with the data associated with the golfing activity to determine an occurrence of the first golfing event; and
performing an action in response to at least the first golfing event and a second golfing event occurring at a specified sequence.

2. The method of claim 1, wherein the collecting step further comprises receiving an entered input signal.

3. The method of claim 1, wherein the collecting step further comprises receiving positional information generated by a global positioning system (GPS).

4. The method of claim 2, wherein the entered input signal causes a stroke increment.

5. The method of claim 4, further comprising displaying the stroke increment.

6. The method of claim 4, wherein the entered input signal causes the positional information to be obtained close to a time the entered input signal is received.

7. The method of claim 1, wherein the condition includes completing play of a golf hole.

8. The method of claim 2, wherein the entered input signal satisfies the condition, and the condition includes completing play of the golf hole.

9. The method of claim 3, wherein the condition includes identifying the positional information to be within a terrain of a golf hole.

10. The method of claim 1, wherein the performing step further includes displaying map information of a golf hole in response to the first golfing event and the second golfing event having occurred at the specified sequence indicating play for the golf hole is in process.

11. The method of claim 1, wherein the performing step further includes processing the data associated with a golf hole in response to the first golfing event and the second golfing event having occurred at the specified sequence indicating teeing off the golf hole.

12. The method of claim 11, wherein the processing step further includes determining fairway in regulation (FIR).

13. The method of claim 11, wherein the processing step further includes calculating a driving distance.

14. The method of claim 1, wherein the processing step further includes determining green in regulation (GIR) in response to the first golfing event of continuing play outside of a green of a golf hole having occurred prior to the second golfing event of being on the green of the golf hole.

15. The method of claim 1, wherein the performing step further includes making a club selection suggestion.

16. The method of claim 1, further comprising:
comparing timing information associated with the first golfing event and the second golfing event to determine a sequence of occurrences; and
checking the sequence of occurrences against the specified sequence.

17. The method of claim 1, further comprising checking whether the first golfing event has occurred before considering the occurrence of the second golfing event, if the specified sequence is for the first golfing event to occur prior to an occurrence of the second golfing event.

18. A device for providing golfing information, the device comprises:
a memory unit;
an input device and a positioning module configured to collect data associated with a golfing activity; and
a processing unit configured to
compare a condition associated with a first golfing event with the data associated with the golfing activity to determine an occurrence of the first golfing event, and
perform an action in response to at least the first golfing event and a second golfing event occurring at a specified sequence.

19. The device of claim 18, wherein the data associated with the golfing activity includes an entered input signal, positional information, or a combination of the entered input signal and the positional information.

20. The device of claim 19, wherein the entered input signal causes a stroke increment.

21. The device of claim 20, further comprising a display device that displays the stroke increment.

22. The device of claim 20, wherein the entered input signal causes the processing unit to retrieve the positional information close to a time the entered input signal is received.

23. The device of claim 18, wherein the condition includes completing play of a golf hole.

24. The device of claim 19, wherein the entered input signal satisfies the condition, and the condition includes completing play of the golf hole.

25. The device of claim 19, wherein the entered input signal is generated by pressing a button on the input device.

26. The device of claim 19, wherein the condition includes identifying the positional information to be within a terrain of a golf hole.

27. The device of claim 18, wherein the processing unit is further configured to display map information of a golf hole on a display device in response to the first golfing event and the second golfing event having occurred at the specified sequence indicating play for the golf hole is in process.

28. The device of claim 18, wherein the processing unit is further configured to process the data associated with a golf hole in response to the first golfing event and the second golfing event having occurred at the specified sequence indicating teeing off the golf hole.

29. The device of claim 28, wherein the processing unit is further configured to process the data to determine fairway in regulation (FIR).

30. The device of claim 28, wherein the processing unit is further configured to process the data to calculate a driving distance.

31. The device of claim 18, wherein the processing unit is further configured to process the data to determine green in regulation (GIR) in response to the first golfing event of continuing play outside of a green of a golf hole having occurred prior to the second golfing event of being on the green of the golf hole.

32. The device of claim 18, wherein the processing unit is further configured to make a club selection suggestion.

33. The device of claim 18, wherein the processing unit is further configured to:
compare timing information associated with the first golfing event and the second golfing event to determine a sequence of occurrences; and
check the sequence of occurrences against the specified sequence.

34. The device of claim 18, wherein the processing unit is further configured to check whether the first golfing event has occurred before considering the occurrence of the second golfing event, if the specified sequence is for the first golfing event to occur prior to an occurrence of the second golfing event.

35. A computer readable medium containing a sequence of programming instructions for providing golfing information, which when executed by a processing unit in a device, causes the device to:
collect data associated with a golfing activity;
compare a condition associated with a first golfing event with the data associated with the golfing activity to determine an occurrence of the first golfing event; and
perform an action in response to at least the first golfing event and a second golfing event occurring at a specified sequence.
